(19) United States
(12) Patent Application Publication
(10) Pub. No.: US 2022/0083883 A1
(43) Pub. Date: Mar. 17, 2022

(54) Probabilistic Error Detection and Correction in Form-Based Input of a User Interface

(71) Applicant: ServiceNow, Inc., Santa Clara, CA (US)

(72) Inventors: Ramkumar Devanathan, Bangalore (IN); Badarinarayan Parthasarathi Burli, Bangalore (IN); Ganesh Parameshwar Bhat, Bangalore (IN)

(21) Appl. No.: 17/023,843

(22) Filed: Sep. 17, 2020

(51) Int. Cl. G06N 7/00; G06F 3/0481; G06F 16/901; G06F 11/07

(52) U.S. Cl. CPC G06N 7/005; G06F 3/0481; G06F 11/0703; G06F 16/9027; G06F 16/9024

(57) ABSTRACT

Persistent storage may contain a definition of a user interface that includes a plurality of inputs, a specification of a graph of dependencies between pairs of inputs in the plurality of inputs, and collected data representing previously-submitted combinations of the plurality of inputs and corresponding indications of successes or errors. One or more processors may be configured to: transmit, to a client device, a representation of the user interface; receive, from the client device, a set of input values corresponding to the plurality of inputs; determine that the set of input values, in combination, results in an error; based on the collected data and the graph, calculate likelihoods respectively corresponding to one or more of the input values, wherein the likelihoods are estimates that the input values corresponding thereto caused the error; and transmit, to the client device, at least one of the likelihoods.

### BACKGROUND

Computing systems are growing more complex and wide-spread. As a consequence, user interfaces that facilitate the configuration and/or operation of these computing systems are also growing more complex and are often not tailored for users with a layperson's background. But, the ubiquity of computing in modern-day life means that laypersons may often be tasked with using, or find that they have to interact with, such computing systems. As an example, a user interface may present a user with multiple required inputs in the form of fields, text boxes, selectors, menus, and so on. Some of these inputs may be interdependent on one another, in that a value selected for one input may limit the values that will be accepted in another input, or some combinations of input values may result in errors. Further, at least some inputs may require a technical understanding of the system with which the user interface is associated, but such knowledge may be difficult to obtain for the average user.

### SUMMARY

The embodiments herein provide an improvement to user interfaces, particularly, in how input errors are detected and communicated to a user. As an example, dependencies between multiple inputs on a user interface may be obtainable from application-specific rules of a software application with which the user interface is associated. Dependencies may also be based on a history of past combinations of inputs and whether these combinations resulted in overall requests that were valid or invalid. Such dependencies may be represented as a graph.

If a request made using the user interface with certain input values fails, the graph can be used to obtain the respective likelihoods that the underlying was due to each of the input values. This can be used to provide the user not just with the fact that the request resulted in an error, but to also suggest to the user which particular input or inputs have the highest likelihoods of having caused the error. In some cases, perhaps based on the historical data or pre-defined configuration, the user may also be provided with one or more suggestions of values that can be used with these inputs that are more likely to result in a successful request.

In this fashion, users who do not have the requisite technical understanding of a complex computing system may be able to configure and use such a system without having to seek help from an expert. This results in an improved user interface paradigm that assists the user in understanding and correcting input errors. Thus, users save time by avoiding long sessions of trial-and-error or having to consult with more knowledgeable users in order to submit successful requests.

Accordingly, a first example embodiment may involve persistent storage containing a definition of a user interface that includes a plurality of inputs, a specification of a graph of dependencies between pairs of inputs in the plurality of inputs, and collected data representing previously-submitted combinations of the plurality of inputs and corresponding indications of successes or errors. The first example embodiment may also involve one or more processors configured to: (i) transmit, to a client device, a representation of the user interface; (ii) receive, from the client device, a set of input values corresponding to the plurality of inputs; (iii) determine that the set of input values, in combination, results in an error; (iv) based on the collected data and the graph, calculate likelihoods respectively corresponding to one or more of the input values, wherein the likelihoods are estimates that the input values corresponding thereto caused the error; and (v) transmit, to the client device, at least one of the likelihoods as an update to the user interface or as a new user interface.

A second example embodiment may involve transmitting, to a client device, a representation of a user interface, wherein persistent storage contains a definition of the user interface that includes a plurality of inputs, a specification of a graph of dependencies between pairs of inputs in the plurality of inputs, and collected data representing previously-submitted combinations of the plurality of inputs and corresponding indications of successes or errors. The second example embodiment may also involve receiving, from the client device, a set of input values corresponding to the plurality of inputs. The second example embodiment may also involve determining that the set of input values, in combination, results in an error. The second example embodiment may also involve, based on the collected data and the graph, calculating likelihoods respectively corresponding to one or more of the input values, wherein the likelihoods are estimates that the input values corresponding thereto caused the error. The second example embodiment may also involve transmitting, to the client device, at least one of the likelihoods as an update to the user interface or as a new user interface.

In a third example embodiment, an article of manufacture may include a non-transitory computer-readable medium, having stored thereon program instructions that, upon execution by a computing system, cause the computing system to perform operations in accordance with the first example embodiment.

In a fourth example embodiment, a computing system may include at least one processor, as well as memory and program instructions. The program instructions may be stored in the memory, and upon execution by the at least one processor, cause the computing system to perform operations in accordance with the first example embodiment.

In a fifth example embodiment, a system may include various means for carrying out each of the operations of the first example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5A depicts another communication environment involving a remote network management architecture, in accordance with example embodiments.

FIG. 5B is a flow chart, in accordance with example embodiments.

FIG. 6 is a message flow diagram, in accordance with example embodiments.

FIG. 7A depicts a graphical user interface, in accordance with example embodiments.

FIG. 7B depicts an error message, in accordance with example embodiments.

FIG. 8A depicts a further graphical user interface, in accordance with example embodiments.

FIG. 8B depicts a graph of dependencies between inputs of the further graphical user interface of FIG. 8A, in accordance with example embodiments.

FIG. 8C depicts decency trees for each of the inputs of the further graphical user interface of FIG. 8A, in accordance with example embodiments.

FIG. 8D depicts suggested input values for the further graphical user interface of FIG. 8A, in accordance with example embodiments.

FIG. 9 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, delete (CRUD) capabilities. This allows new applications to be built on a common application infrastructure.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional MVC application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HTML and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. Example Computing Devices and Cloud-Based Computing Environments

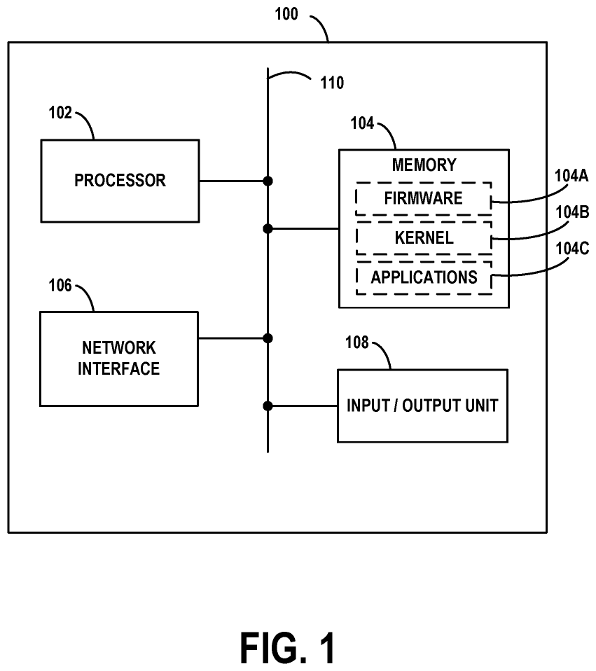

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

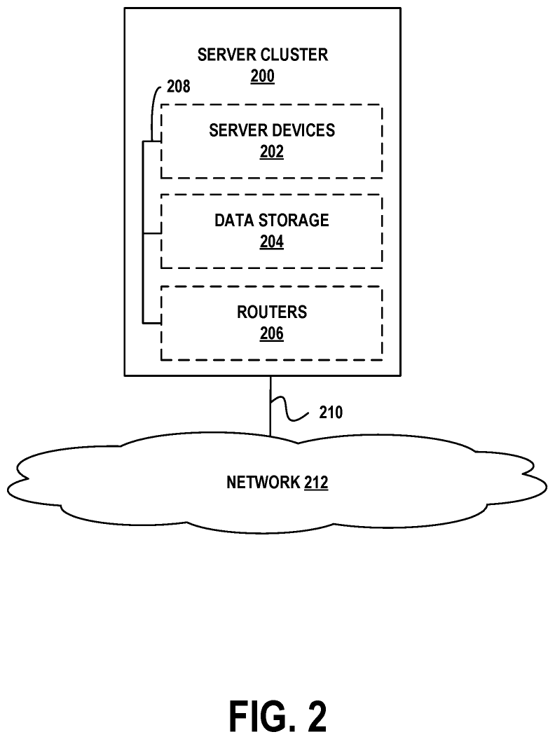

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as the hypertext markup language (HTML), the extensible markup language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. Example Remote Network Management Architecture

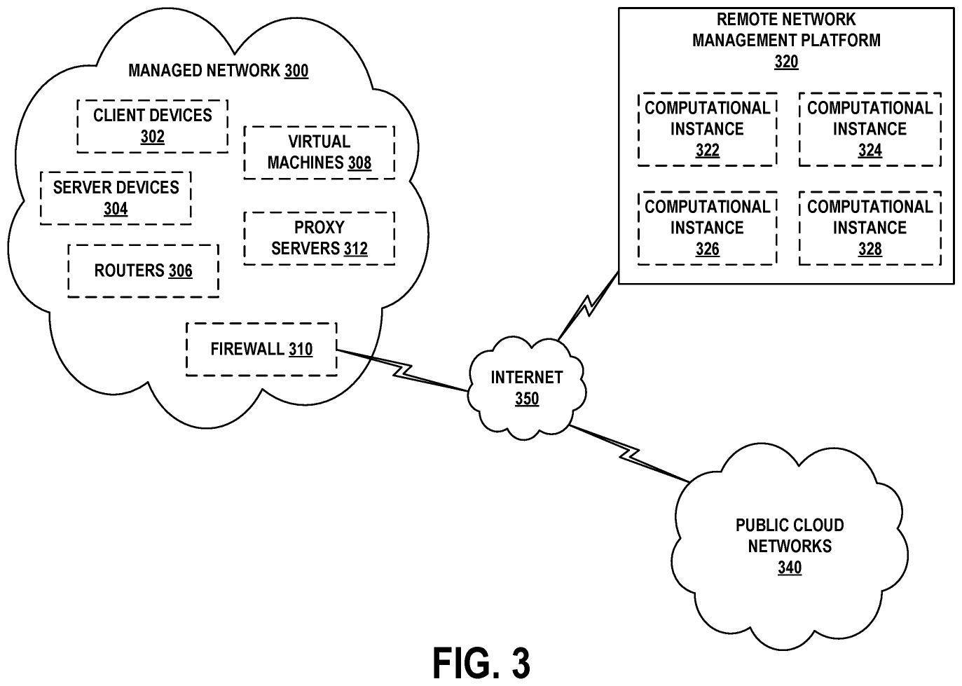

FIG. 3 depicts a remote network management architecture, in accordance with example embodiments. This architecture includes three main components—managed network 300, remote network management platform 320, and public cloud networks 340—all connected by way of Internet 350.

A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components. Possibly with the assistance of proxy servers 312, remote network management platform 320 may also be able to discover and manage aspects of public cloud networks 340 that are used by managed network 300.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may impact all customers' data, creating additional risk, especially for entities subject to governmental, healthcare, and/or financial regulation. Furthermore, any database operations that impact one customer will likely impact all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include AMAZON WEB SERVICES® and MICROSOFT® AZURE®. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

D. Communication Support and Other Operations

Internet 350 may represent a portion of the global Internet. However, Internet 350 may alternatively represent a different type of network, such as a private wide-area or local-area packet-switched network.

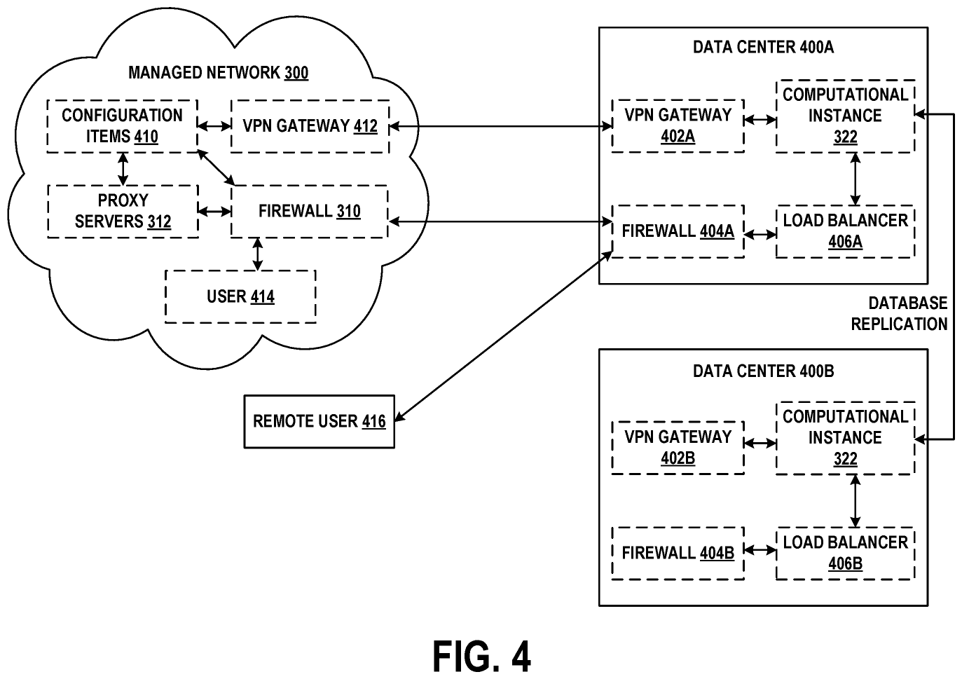

FIG. 4 further illustrates the communication environment between managed network 300 and computational instance 322, and introduces additional features and alternative embodiments. In FIG. 4, computational instance 322 is replicated across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any applications or services executing thereon, as well as relationships between devices, applications, and services. Thus, the term “configuration items” may be shorthand for any physical or virtual device, or any application or service remotely discoverable or managed by computational instance 322, or relationships between discovered devices, applications, and services. Configuration items may be represented in a configuration management database (CMDB) of computational instance 322.

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively).

### IV. Example Device, Application, and Service Discovery

In order for remote network management platform 320 to administer the devices, applications, and services of managed network 300, remote network management platform 320 may first determine what devices are present in managed network 300, the configurations and operational statuses of these devices, and the applications and services provided by the devices, as well as the relationships between discovered devices, applications, and services. As noted above, each device, application, service, and relationship may be referred to as a configuration item. The process of defining configuration items within managed network 300 is referred to as discovery, and may be facilitated at least in part by proxy servers 312.

For purposes of the embodiments herein, an “application” may refer to one or more processes, threads, programs, client modules, server modules, or any other software that executes on a device or group of devices. A “service” may refer to a high-level capability provided by multiple applications executing on one or more devices working in conjunction with one another. For example, a high-level web service may involve multiple web application server threads executing on one device and accessing information from a database application that executes on another device.

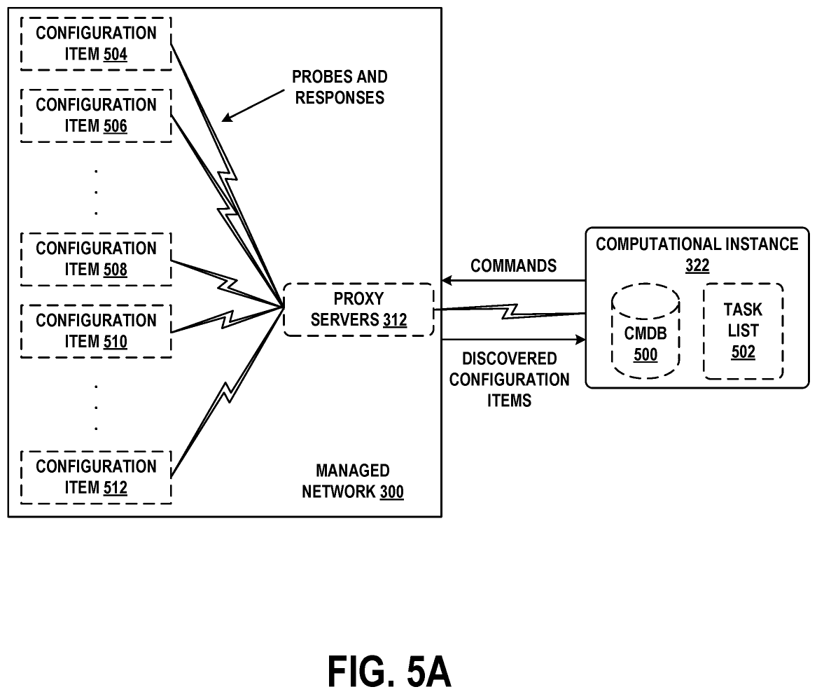

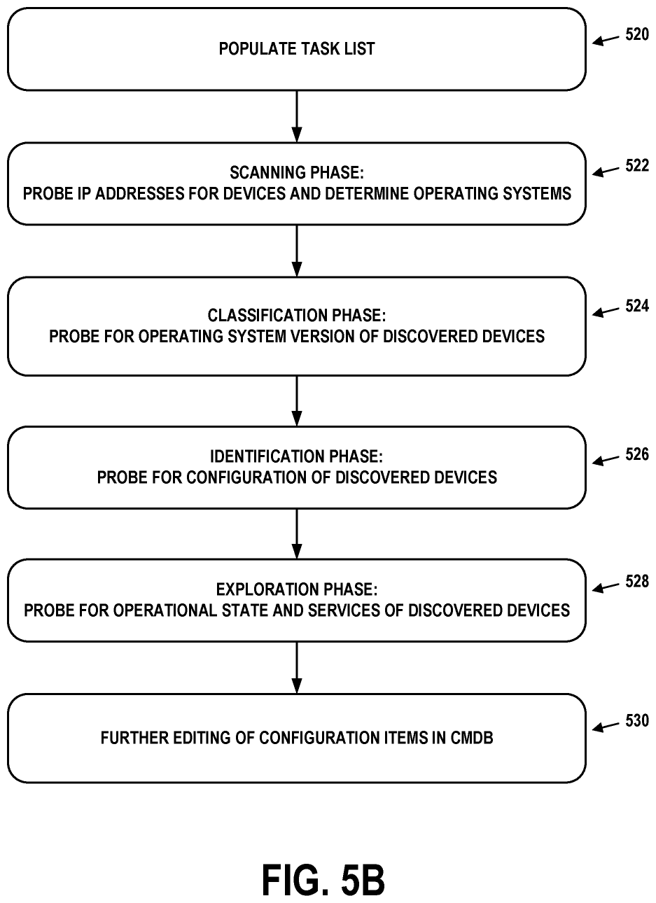

FIG. 5A provides a logical depiction of how configuration items can be discovered, as well as how information related to discovered configuration items can be stored. For sake of simplicity, remote network management platform 320, public cloud networks 340, and Internet 350 are not shown.

In FIG. 5A, CMDB 500 and task list 502 are stored within computational instance 322. Computational instance 322 may transmit discovery commands to proxy servers 312. In response, proxy servers 312 may transmit probes to various devices, applications, and services in managed network 300. These devices, applications, and services may transmit responses to proxy servers 312, and proxy servers 312 may then provide information regarding discovered configuration items to CMDB 500 for storage therein. Configuration items stored in CMDB 500 represent the environment of managed network 300.

Task list 502 represents a list of activities that proxy servers 312 are to perform on behalf of computational instance 322. As discovery takes place, task list 502 is populated. Proxy servers 312 repeatedly query task list 502, obtain the next task therein, and perform this task until task list 502 is empty or another stopping condition has been reached.

To facilitate discovery, proxy servers 312 may be configured with information regarding one or more subnets in managed network 300 that are reachable by way of proxy servers 312. For instance, proxy servers 312 may be given the IP address range 192.168.0/24 as a subnet. Then, computational instance 322 may store this information in CMDB 500 and place tasks in task list 502 for discovery of devices at each of these addresses.

FIG. 5A also depicts devices, applications, and services in managed network 300 as configuration items 504, 506, 508, 510, and 512. As noted above, these configuration items represent a set of physical and/or virtual devices (e.g., client devices, server devices, routers, or virtual machines), applications executing thereon (e.g., web servers, email servers, databases, or storage arrays), relationships therebetween, as well as services that involve multiple individual configuration items.

Placing the tasks in task list 502 may trigger or otherwise cause proxy servers 312 to begin discovery. Alternatively or additionally, discovery may be manually triggered or automatically triggered based on triggering events (e.g., discovery may automatically begin once per day at a particular time).

In general, discovery may proceed in four logical phases: scanning, classification, identification, and exploration. Each phase of discovery involves various types of probe messages being transmitted by proxy servers 312 to one or more devices in managed network 300. The responses to these probes may be received and processed by proxy servers 312, and representations thereof may be transmitted to CMDB 500. Thus, each phase can result in more configuration items being discovered and stored in CMDB 500.

In the scanning phase, proxy servers 312 may probe each IP address in the specified range of IP addresses for open Transmission Control Protocol (TCP) and/or User Datagram Protocol (UDP) ports to determine the general type of device. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist. Once the presence of a device at a particular IP address and its open ports have been discovered, these configuration items are saved in CMDB 500.

In the classification phase, proxy servers 312 may further probe each discovered device to determine the version of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 2012, as a set of WINDOWS®-2012-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (applications), and so on. Once more, the discovered information may be stored as one or more configuration items in CMDB 500.

Running discovery on a network device, such as a router, may utilize SNMP. Instead of or in addition to determining a list of running processes or other application-related information, discovery may determine additional subnets known to the router and the operational state of the router's network interfaces (e.g., active, inactive, queue length, number of packets dropped, etc.). The IP addresses of the additional subnets may be candidates for further discovery procedures. Thus, discovery may progress iteratively or recursively.

Once discovery completes, a snapshot representation of each discovered device, application, and service is available in CMDB 500. For example, after discovery, operating system version, hardware configuration, and network configuration details for client devices, server devices, and routers in managed network 300, as well as applications executing thereon, may be stored. This collected information may be presented to a user in various ways to allow the user to view the hardware composition and operational status of devices, as well as the characteristics of services that span multiple devices and applications.

Furthermore, CMDB 500 may include entries regarding dependencies and relationships between configuration items. More specifically, an application that is executing on a particular server device, as well as the services that rely on this application, may be represented as such in CMDB 500. For example, suppose that a database application is executing on a server device, and that this database application is used by a new employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular router fails.

In general, dependencies and relationships between configuration items may be displayed on a web-based interface and represented in a hierarchical fashion. Thus, adding, changing, or removing such dependencies and relationships may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

In order for discovery to take place in the manner described above, proxy servers 312, CMDB 500, and/or one or more credential stores may be configured with credentials for one or more of the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

The discovery process is depicted as a flow chart in FIG. 5B. At block 520, the task list in the computational instance is populated, for instance, with a range of IP addresses. At block 522, the scanning phase takes place. Thus, the proxy servers probe the IP addresses for devices using these IP addresses, and attempt to determine the operating systems that are executing on these devices. At block 524, the classification phase takes place. The proxy servers attempt to determine the operating system version of the discovered devices. At block 526, the identification phase takes place. The proxy servers attempt to determine the hardware and/or software configuration of the discovered devices. At block 528, the exploration phase takes place. The proxy servers attempt to determine the operational state and applications executing on the discovered devices. At block 530, further editing of the configuration items representing the discovered devices and applications may take place. This editing may be automated and/or manual in nature.

The blocks represented in FIG. 5B are examples. Discovery may be a highly configurable procedure that can have more or fewer phases, and the operations of each phase may vary. In some cases, one or more phases may be customized, or may otherwise deviate from the exemplary descriptions above.

In this manner, a remote network management platform may discover and inventory the hardware, software, and services deployed on and provided by the managed network. As noted above, this data may be stored in a CMDB of the associated computational instance as configuration items. For example, individual hardware components (e.g., computing devices, virtual servers, databases, routers, etc.) may be represented as hardware configuration items, while the applications installed and/or executing thereon may be represented as software configuration items.

The relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

The relationship between a service and one or more software configuration items may also take various forms. As an example, a web service may include a web server software configuration item and a database application software configuration item, each installed on different hardware configuration items. The web service may have a “depends on” relationship with both of these software configuration items, while the software configuration items have a “used by” reciprocal relationship with the web service. Services might not be able to be fully determined by discovery procedures, and instead may rely on service mapping (e.g., probing configuration files and/or carrying out network traffic analysis to determine service level relationships between configuration items) and possibly some extent of manual configuration.

Regardless of how relationship information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

### V. CMDB Identification Rules and Reconciliation

A CMDB, such as CMDB 500, provides a repository of configuration items, and when properly provisioned, can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information related to configuration items in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API). This API may use a set of configurable identification rules that can be used to uniquely identify configuration items and determine whether and how they are written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to the identification and reconciliation API, the API may attempt to match the information with one or more rules. If a match is found, the configuration item is written to the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, the identification and reconciliation API will only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by reconciliation procedures or in another fashion. These configuration items may be flagged for manual de-duplication.

### VI. User Interface Challenges

As noted, remote network management platform 320 may support a number of applications that provide various enterprise services used by managed network 300. These applications may be web-based, in that their configuration, management, and use may be facilitated by user interfaces in the form of web pages. In many embodiments, such a web page may prompt the user for multiple inputs. These inputs may be in the form of fields, text boxes, selectors, menus, and so on. A combination of the inputs on a particular web page (or across multiple web pages) may be referred to as a request. Typically, only certain requests are valid, with all other combinations of inputs being invalid or at least not achieving a desirable result.

A problem that exists in modern computing is that web interfaces can be complex and involve many inputs. Dependencies between these inputs may exist, and understanding these dependencies may require expertise in the underlying application that is presenting the user interface. As more and more managed networks adopt the services of a remote network management platform, more users will be required or expected to navigate remote network management platform applications and their associated user interfaces. Some of these users are likely to be laypersons who are either newcomers to the remote network management platform applications, unfamiliar with these applications, or use them so infrequently that remembering how to navigate their user interfaces can be challenging.

As a consequence, users often struggle to provide proper requests to remote network management platform applications. Invalid requests may result in error messages being displayed to the user. But such error messages can often be cryptic and once again require a certain level of familiarity with the application at hand in order to decipher.

The embodiments herein address these and other problems by providing indications of particular input(s) that may be the cause of errors in requests. These indications may be based on a probabilistic analysis of dependencies between the inputs that constitute the requests. Thus, rather than the user guessing at which inputs might be causing a request to fail, the input(s) most likely to have caused the failure can be identified. Further, in some cases, a valid input may be suggested to the user.

Integration of these embodiments into a remote network management platform application improves the functioning of its user interfaces by providing more helpful responses to errors in requests. Doing so eases navigation and saves time for all users, and especially helps non-expert users by reducing their reliance on having to look up how to use the application or seek help from other users.

While the embodiments herein focus on applications supported by a remote network management platform, these embodiments could be used with other types of user interfaces. Nonetheless, data stored within the remote network management platform can be used to determine dependencies and carry out the aforementioned probabilistic analysis. Thus, a remote network management platform may be particularly well-situated to support these embodiments.

As an illustrative example, some remote network management platform applications may facilitate configuring services provided by public cloud networks, such as public cloud networks 340. As noted above, public cloud networks may support configuration and use of various types of computing resources that can perform operations on behalf of a managed network. Thus, remote network management platform applications may provide one or more user interfaces through which one can allocate, edit, de-allocate, and manage these computing resources.

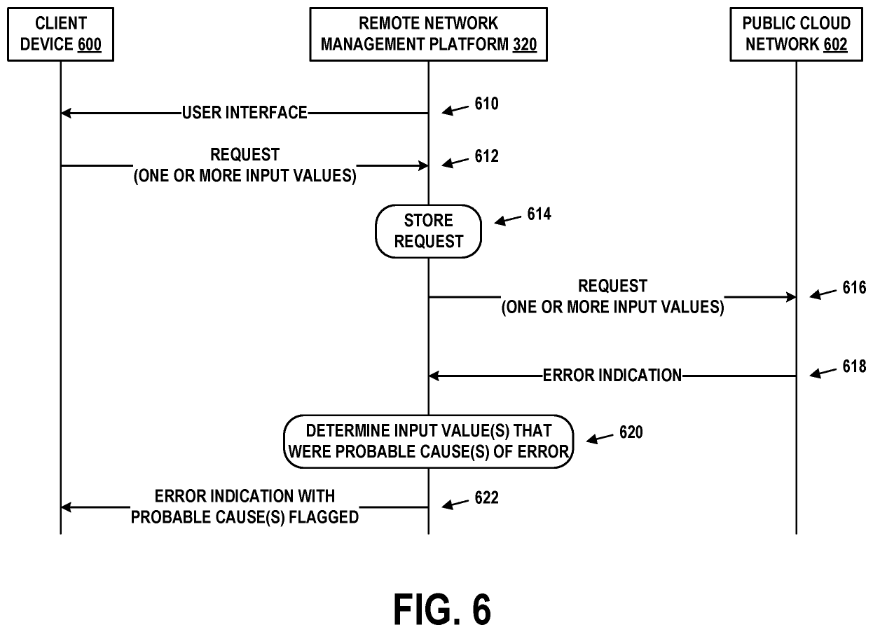

FIG. 6 is a message flow diagram depicting a transaction in which a user attempts to make web-mediated request to a public cloud network by way of a remote network management platform. Particularly, the user may operate client device 600 to make the request by way of remote network management platform 320 to public cloud network 602. Client device 600 may be associated with managed network 300—for example, client device 600 may be disposed upon managed network 300 and/or client device 600 may be logged on to an account associated with managed network 300.

At step 610, remote network management platform 320 may transmit a representation of a user interface to client device 600. This representation may be transmitted in response to a previous instruction that remote network management platform 320 received from client device 600, for example. In response to receiving the representation, client device 600 may render the user interface on a display. This user interface may include, for example, a web page with one or more inputs that prompt the user to enter corresponding input values that relate to public cloud network 602. For example, the combination of these inputs may define one or more resources to be allocated on public cloud network 602 on behalf of client device 600.

The user of client device 600 may fill out these inputs with input values and submit these input values by way of a button or other actuatable mechanism on the web page. The combination of the input values may be referred to as a “request”.

At step 612, this request may be transmitted from client device 600 to remote network management platform 320.

At step 614, remote network management platform 320 may store at least part of the request. For example, the input values may be stored along with indications of the inputs to for which they were entered.

At step 616, the request may be transmitted from remote network management platform 320 to public cloud network 602. In some cases, more or less information than was present in the request of step 612 may be provided in this request.

Public cloud network 602 may process this request and provide, in response, a success indication if the request was successful or an error indication if public cloud network 602 detected an error in the request. For sake of illustration, it is assumed that the request results in an error.

At step 618, an error indication may be transmitted from public cloud network 602 to remote network management platform 320. This error may have various formats and may contain various types of information.

At step 620, remote network management platform 320 may determine that one or more of the input values were probable causes of the error. As described in more detail below, remote network management platform 320 may calculate a probability or other form of likelihood that each input value caused the error. Herein the terms “probability” and “likelihood” may be used synonymously in some situations. In general, the sum of all probabilities for a random variable is 1.0, while this may not be the case for likelihoods. Thus, likelihoods may encompass probabilities, but may also be expressed more broadly.

At step 622, remote network management platform 320 may transmit an error indication to client device 600. This error indication may flag or otherwise identify one or more of the input values with the highest probabilities (e.g., the one two or three input values with the highest probabilities) or any input value with a probability over a threshold value (e.g., 15%, 20%, 30%). The error indication may result in the user interface provided in step 610 being updated, or the error indication may be a new user interface.

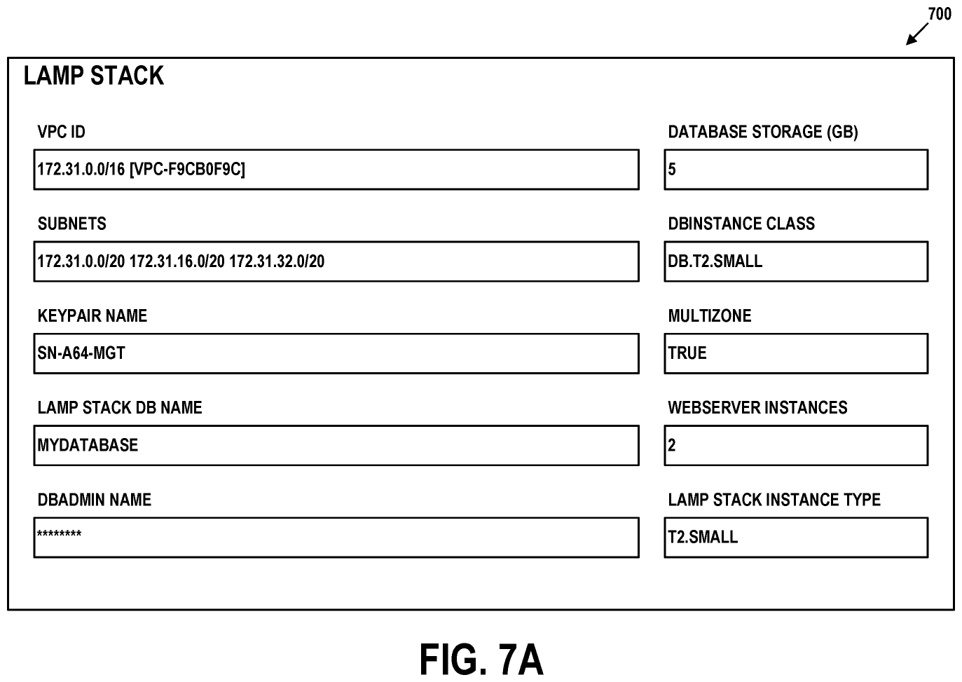

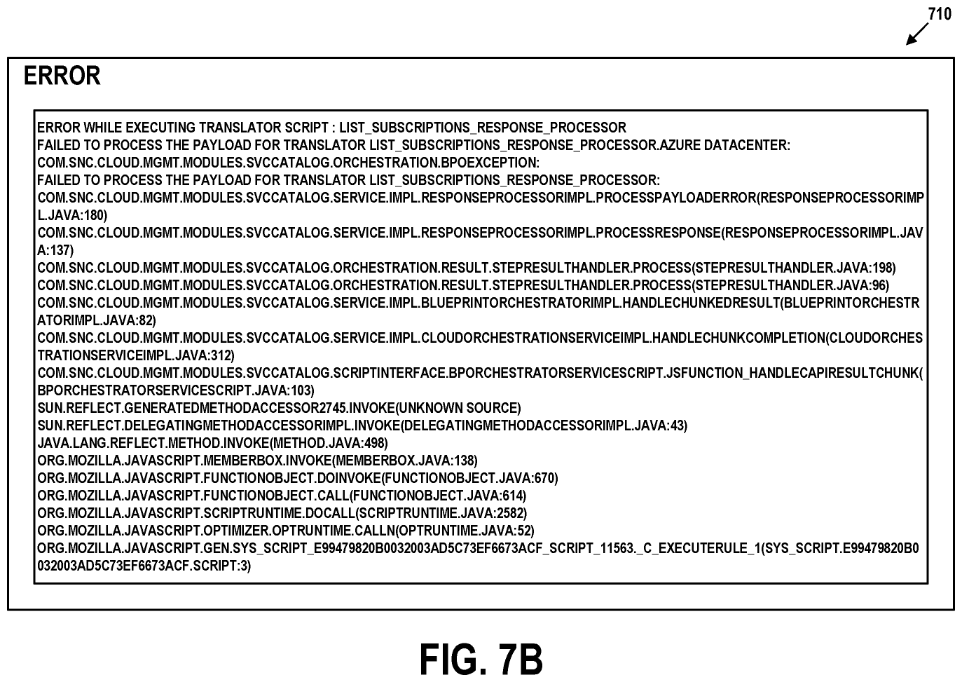

In line with the discussion of FIG. 6, FIGS. 7A and 7B provide a practical example of the challenges surrounding providing input values to a user interface that provisions services on a public cloud network, as well as the difficulties presented by related error messages. FIG. 7A depicts user interface 700 with 10 inputs configured to receive input values related to a configuring a LINUX®, Apache, MYSQL®, PHP (LAMP) web server and associated database. The inputs include a number of technical identifiers and properties of the web server and database, including a VPC ID, subnets, a keypair, name, storage amount, class, number of instances, and so on. Example input values are provided.

Some of these inputs may be dependent upon the input values entered for other inputs. For example, input values for the subnets input may need to define subnets that are contained topologically within the network defined in the VPC ID input. Other examples of dependencies may exist. As noted above, this creates a burden on the user who not only has to understand the technical requirements of what he or she is requesting by way of the user interface (in this case, a LAMP stack), but also that certain combinations of individual inputs may be valid or invalid.

Furthermore, if the user submits a request with one or more invalid input values, the system may produce an error message that is difficult to decipher. To that point, FIG. 7B depicts such an error message 710. It is unlikely that a layperson would be able to understand which input value(s) were invalid based on such an error message. In fact, even a user with a strong technical background may not be able to easily determine a root cause of the error from such a message.

### VII. Probabilistic Error Detection

The embodiments here address these and possibly other issues by calculating the probabilities that various input values of a request may be the root cause of an error associated with the request. Based on these probabilities, input value(s) that are the likely cause of the error can be identified to the user.

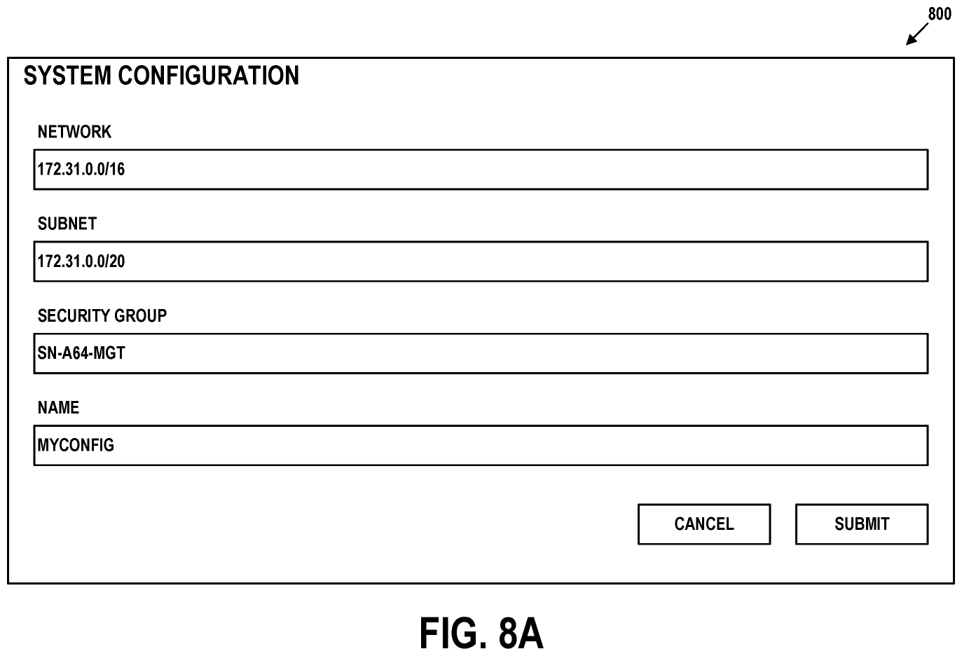

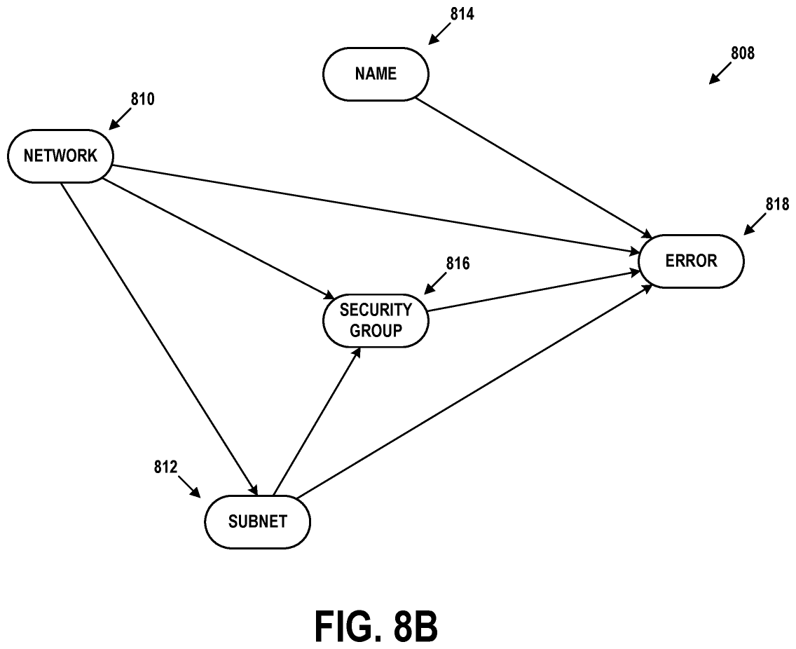

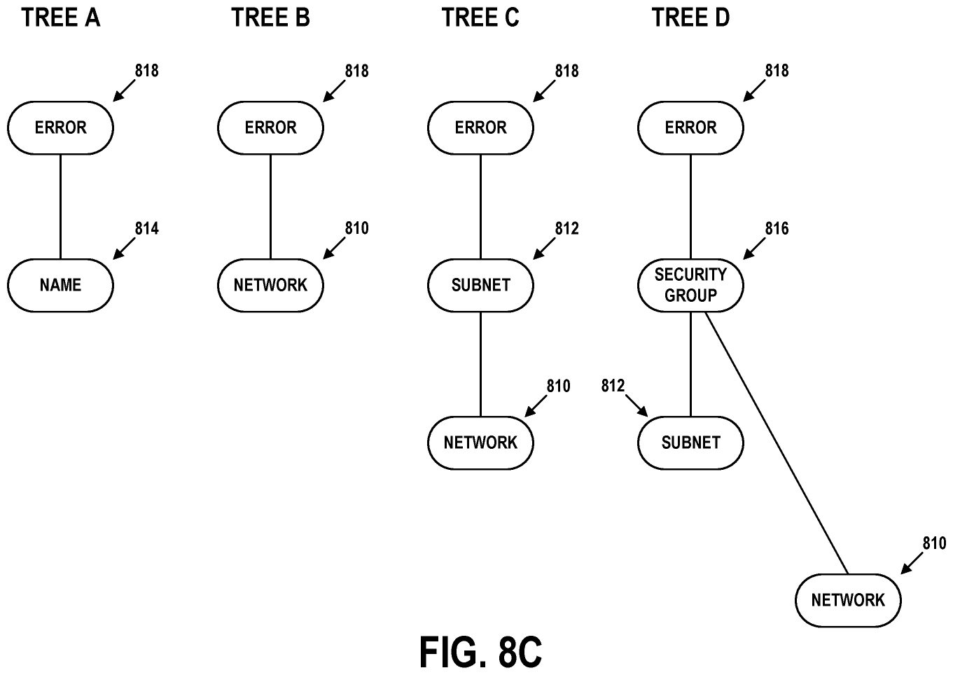

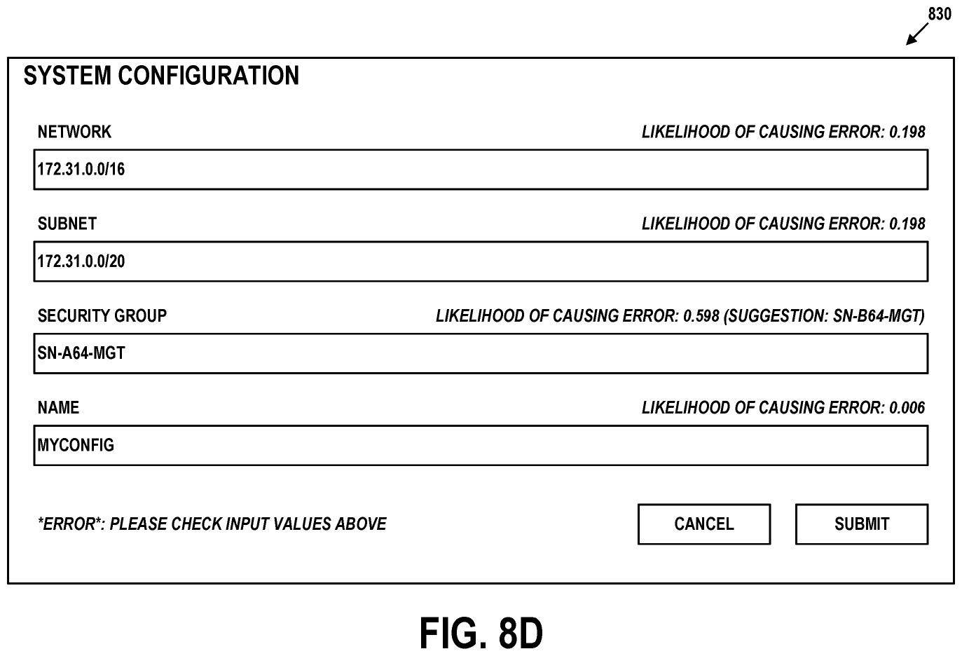

To illustrate the operation of these embodiments, a simple example user interface is provided in FIG. 8A. User interface 800 includes four inputs: network, subnet, security group, and name. Example input values are provided. These inputs define an arbitrary system (e.g., a virtual machine configuration).

FIG. 8B depicts the dependencies between these inputs as graph 808. Nodes 810, 812, 814, and 816 of the graph represent inputs (network, subnet, name, and security group, respectively) from user interface 800. Node 818 represents an error resulting from a request that constitutes a particular set of input values.

The arrows of graph 808 represent dependencies. Aside from node 818, the input value of the node at an arrow's destination depends upon the input value of the node at the arrow's source. In such a relationship, the node at the arrow's source may be referred to as the parent, and the node at an arrow's destination may be referred to as the child.

For instance, input values for subnet 812 depend upon input values for network 810, because values of a subnet are constrained by the network in which the subnet is disposed. Input values for security group 816 may depend upon input values for both network 810 and subnet 812, because values of a security group rely on both the network and subnet for which it is configured (here, a security group may be considered to be a firewall, packet filter, or access control list that filters traffic between the subnet and another network). On the other hand, input values for name 814 does not depend on any other input values. This may be because the system being configured can be named with any alphanumeric string, for example.

Error 818 represents a hypothetical error. Such an error may occur due to invalid input values or combinations thereof in any of the inputs. Thus, error 818 depends on all of the inputs, but does not have an input value of its own.

Graph 808 may be considered to form a Bayesian belief network (or Bayesian network for short), representing a set of dependencies between its nodes. As described below, these dependencies may take the form of probabilities, and the probabilities may be updated from time to time in order to train the network and thereby improve its predictive abilities.

Note that while the dependencies in graph 808 can be modeled as a directed acyclic graph, implementations of this graph may have bidirectional edges for purposes of efficiency. In particular, and as described in more detail below, it is advantageous to be able to backtrack through the graph from a given node to some or all of its ancestor nodes on which the given node depends. Thus, any discussions of graphs—such as graph 808—being acyclic is for purposes of convenience, and an actual implementation of the embodiments herein may use bidirectional graphs.

A. Determining Dependencies

In order to construct a graph for the inputs of a user interface, dependencies between these inputs should be determined. Such dependencies may be derived in a number of ways.

In some embodiments, these dependencies may be manually determined. For example, subject matter experts may review the inputs of a particular graphical user interface and decide which of these inputs rely on other inputs. From this, the graph can be constructed.

But in some cases, dependencies can be partially or wholly determined automatically. For example, the user interface may be presented as a web page consisting of one or more client-side scripts (e.g., JAVASCRIPT®). These scripts may include onLoad and onChange rules. The onLoad rules may be carried out when the web page is loaded, and the onChange rules may be carried out when the input value of a certain input in the web page is changed. As an illustration of this, consider user interface 800. An initial representation of this user interface may omit the subnet input. But selection of an input value for the network input may cause the subnet input to appear. This indicates that the subnet input has a dependency on the network input (i.e., the network is the parent and the subnet is the child). Scanning the client side scripts for similar types of relationships between inputs can be used to determine the dependencies.

In another example, metadata rules from the CMDB identification and reconciliation engine can be used to determine dependencies. Some of these rules may identify relationships between configuration items, and/or relationships between attributes of a configuration item. For example, two virtual machines may depend on a unit of storage (e.g., a hard drive). Thus, the unit of storage may be the parent and each of the virtual machines may be its children. Therefore, scanning identification and reconciliation rules associated with the CMDB may also be used to identify dependencies.

In yet another example, a managed network may define pool filters that limit the input values usable in certain inputs of a user interface for certain users. For instance, a filter may specify that users with lower privilege settings cannot use a particular group of subnets, while users with higher privilege settings can use this group of subnets. The presence of such a filter indicates a dependency between a user's privilege settings and the group of subnets, where the privilege settings are the parent and each subnet in the group of subnets is a child. Thus, scanning pool filters may also be used to identify dependencies.

Data from manual configuration, onLoad and onChange rules, identification and reconciliation rules, and pool filters may be combined in various ways to derive dependencies. Thus, the dependencies can be determined from a number of sources.

Furthermore, once the user interface is deployed, data can be collected for each request that is entered. This data may include per request, the request's input values, whether it resulted in success or an error, and possibly other information as well. The data can be analyzed to determine which input values tend to be correlated with one another and dependencies can be infer from these correlations. For example, if a network input value of 172.31.0.0/16 is always accompanied by security group values of SN-A64-MGT or SN-A64-USR, a dependency may be inferred between the network and security group inputs.

B. Determining Error Probabilities for Input Values

A graph representing input values of a user interface can be constructed as described above. When a request results in an error, this graph can serve as a probability distribution network to determine the respective probabilities that given input values of the request have caused the error. In order to calculate these probabilities, some terminology is defined below.

Let P(x) be the probability that some event x occurs. Additionally, let P(x|y) be the conditional probability that some event x occurs given that some other event y has occurred. Notably, P(x|y)=P(xy)/P(y). Put another way, this equation indicates that the probability that some event x occurs given that some other event y has occurred is the joint probability of both events x and y occurring divided by the probability of event y occurring. For sake of clarity, event x is called the conditioned event and event y is called the conditioning event.

The principle of conditional probability can be expanded to support multiple conditioning events as P(x|y₁y₂ . . . yₙ)=P(xy₁y₂ . . . yₙ)|P(y₁y₂ . . . yₙ). In other words, the probability that event x occurs given that events y₁y₂ . . . yₙ have occurred is the joint probability that events x, and y₁y₂ . . . yₙ all occur divided by the probability that events y₁y₂ . . . yₙ occur.

When a particular set of input values is provided by way of a user interface, such as user interface 800, conditional probabilities can be applied to estimate the likelihood that each of these input values are the cause of the error. This is accomplished by traversing the dependencies represented by graph 808 in reverse order.

Particularly, in view of a particular set of input values, the conditional probability that an error is caused by any particular input taking on a respective value is calculated as follows. First, determine from the graph all parent inputs on which the particular input depends (if any). Second, set the probability of an error as the conditioned event in a conditional probability expression. Third, the conditioning events in the conditional probability expression are set as the product of (i) the probability of the respective value occurring for the particular input, and (ii) the probabilities of the respective values occurring for the corresponding parent inputs.

The probabilities of the values for the parent inputs can be found by viewing the particular input as the node of a tree overlaid atop the graph, with the branches of the tree extending backwards through the graph toward (and encompassing) the parent inputs. Thus, a tree is generated for each node representing an input by conducting a full search (e.g., depth-first or breadth-first) of the node's dependencies. The resulting set of trees can be illustrated by example with reference to graph 808.

FIG. 8C depicts tree A, tree B, tree C, and tree D, representing the inputs used for calculating probabilities for name, network, subnet, and security group, respectively. For all of these trees, node 818 (representing an error in a request) is the root and the conditioned event. In some embodiments, the node representing the error is omitted and the tree has the node representing the input of interest as its root.

Tree A consists of node 814 (representing a name in a request) as a child of node 818. This tree is generated by traversing graph 808 starting from node 814 and navigating backward through its dependencies. Since node 814 does not depend on any other nodes (i.e., the input value for a name does not depend on any other input values), there are no other nodes in tree A.

Similarly, tree B consists of node 810 (representing a network in a request) as a child of node 818. This tree is generated by traversing graph 808 starting from node 810 and navigating backward through its dependencies. Since node 810 does not depend on any other nodes (i.e., the input value for a network does not depend on any other input values), there are no other nodes in Tree B.

Tree C consists of node 812 (representing a subnet in a request) as a child of node 818, and node 810 (representing a network in a request) as a child of node 812. This tree is generated by traversing graph 808 starting from node 812 and navigating backward through its dependencies. Since node 812 depends on node 810, node 810 is added to tree C.

Tree D consists of node 816 (representing a security group in a request) as a child of node 818, and nodes 810 (representing a network in a request) and node 812 (representing a subnet of a request) as children of node 812. This tree is generated by traversing graph 808 starting from node 816 and navigating backward through its dependencies. Since node 816 depends on nodes 810 and 812, nodes 810 and 812 are added to tree D. Note that even though node 812 has a dependency on node 810, this dependency need not be reflected in tree D since the goal of building the trees is to identify all of the dependent nodes regardless of dependency structure.

TABLE 1

| | Proba- | Conditional Probability Occurring |
|---|---|---|
| Input | bility | with an Error |
| Name | P(n) | P(error\|n) = P(error, n)/P(n) |
| Network | P(nw) | P(error\|nw) = P (error, nw)/P(nw) |
| Subnet | P(sn) | P(error\|sn, nw) = P(error, sn, nw)/P(sn, nw) |
| Security Group | P(sg) | P(error\|sg, sn, sw) = P(error, sg, sn, nw)/ |
| | | P(sg, sn, nw) |

Based on these properties, the conditional probabilities for estimating the likelihood that particular input values of each input are the cause of an error can be derived. For purposes of example, conditional probabilities based on the user interface of FIG. 8A, associated graph 808 of FIG. 8B, and the trees of FIG. 8C are shown in Table 1. Interpretation of each row of this table is as follows.

The probability that a particular name has an input value of n is given as P(n). The conditional probability of an error occurring when name n appears as an input value is estimated as P(error|n)=P(error,n)/P(n). Here and in the following explanations of equations, P(x,y) is the joint probability that both events x and y occur—the comma is added between x and y for sake of clarity.

The probability that a particular network has an input value of nw is given as P(nw). The conditional probability of an error occurring when network nw appears as an input value is estimated as P(error|nw)=P(error,nw)/P(nw).

The probability that a particular subnet has an input value of sn is given as P(sn). The conditional probability of an error occurring when subnet sn appears as an input value is estimated as P(error|sn,nw)=P(error,sn,nw)|P(sn,nw). Due to the dependency of the subnet input value on the network input value, the joint probability of P(sn, nw) is used.

The probability that a particular security group has an input value of sg is given as P(sg). The conditional probability of an error occurring when security group sg appears as an input value is estimated as P(error|sg,sn,nw)=P(error,sg,sn,nw)/P(sg,sn,nw). Due to the dependency of the security group input value on the subnet input value and the network input value, the joint probability of P(sg,sn,nw) is used.

Based on these principles, any acyclic dependency structure between inputs of a user interface can be represented as a conditional probability expression. When an error occurs in a request involving such inputs, the expression can be used to identify one or more particular inputs that are most likely to have caused an error.

But in order for the conditional probability calculations of Table 1 to be carried out, the system should have access to data from which the relevant conditional probabilities can be derived. While these values can be estimated, it is preferred to be able to derive these values from historical data. For example, the system may collect previous sets of input values entered into the user interface and store these in a database. From this empirical data, the relevant conditional probabilities can be calculated. Further, as more and more data is collected and stored for a given user interface, the more accurate these calculations become. An illustrative example is provided below.

TABLE 2

| | | | | Security | |
|---|---|---|---|---|---|
| Request | Name | Network | Subnet | Group | Result |
| 1 | VM1 | Network1 | Subnet1 | SG1 | Success |
| 2 | VM2 | Network1 | Subnet2 | SG2 | Success |
| 3 | VM3 | Network1 | Subnet1 | SG1 | Success |
| 4 | VM4 | Network1 | Subnet1 | SG1 | Success |
| 5 | VM5 | Network1 | Subnet1 | SG1 | Success |
| 6 | VM6 | Network2 | Subnet100 | SG100 | Success |
| 7 | VM7 | Network2 | Subnet100 | SG100 | Success |
| 8 | VM8 | Network2 | Subnet99 | SG99 | Success |
| 9 | VM9 | Network2 | Subnet99 | SG100 | Error |
| 10 | VM10 | Network2 | Subnet100 | SG99 | Error |
| 11 | VM11 | Network2 | Subnet99 | SG99 | Success |
| 12 | VM12 | Network1 | Subnet1 | SG2 | Success |
| 13 | VM13 | Network1 | Subnet2 | SG2 | Error |
| 14 | VM14 | Network1 | Subnet2 | SG2 | Success |

Table 2 provides an example series of requests that could be made with user interface 800. It is assumed that the inputs of user interface 800 exhibit the dependency structure of graph 808.

For example, request 8 includes as inputs a name of VM8, a network of network2, a subnet of subnet99, and a security group of SG99. This request resulted in a success. On the other hand, request 9 includes as inputs a name of VM9, a network of network2, a subnet of subnet99, and a security group of SG100. This request resulted in an error. The error may have been caused, for instance, by security group SG100 being invalid in combination with one or more of network2 and subnet99.

Historical data, such as that shown in Table 2, can be used to derive the conditional probabilities of Table 1. In practice, there may be much more historical data than shown here (e.g., hundreds or thousands of entries). In general, the more historical data that is available, the more accurate the embodiments herein can become due to the Bayesian nature of the calculations. But even if little historical data is initially available, predictions can still be made based on initial prior probabilities assigned to these input values. Examples of how these initial prior probabilities can be assigned are given below, but for now it is assumed that they exist.

To illustrate, suppose that the prior probabilities are P(error|n)=0.01 for an arbitrary name n, P(error|nw)=0.30 for an arbitrary network nw, P(error|sn)=0.35 for an arbitrary subnet sn, and P(error|sg)=0.34 for an arbitrary security group sg. Note that these probabilities should (and do) sum to 1.0, because when there is an error at least one of the input values is the cause.

Suppose further than a new request is made with the following input values: name is VM15, network is network2, subnet is subnet99, and security group is SG100. From the prior probabilities and the historical data of Table 2, the relevant probabilities as set forth in Table 1 can be found. These appear in Table 3.

TABLE 3

| | | Raw | Final |
|---|---|---|---|
| Conditional Probability | Derivation | Value | Value |
| P(error\|VM15) | Prior probabilities | 0.01 | 0.006 |
| P(error\|network2) | $\frac{P ( error , network 2 )}{P ( network 2 )} = \frac{0.14}{0.43}$ | 0.33 | 0.198 |
| P(error\|subnet99, network2) | $\frac{P ( error , subnet 99 , network 2 )}{P ( subnet 99 , network 2 )} = \frac{0.07}{0.21}$ | 0.33 | 0.198 |
| P(error\|SG100, subnet99, network2) | $\frac{P ( error , SG 100 , subnet 99 , network 2 )}{P ( SG 100 , subnet 99 , network 2 )} = \frac{0.07}{0.07}$ | 1.00 | 0.598 |

As shown in Table 3, the raw values that each input value has caused an error can be estimated based on the historical data and prior probabilities. These raw values are rounded to the nearest hundredth.

The raw values can be normalized into a set of final likelihood values that sum to 1.0, thus representing probabilities. For example, given a set of raw values pⱼ, where 1≤i≤n, the respective final likelihoods can be calculated as:

$$\frac{{p}_{i}}{{\sum }_{j = 1}^{n} {p}_{j}}$$

Table 3 also shows theses final values rounded to the nearest thousandth. It can easily be verified that the sum of all four final values is 1.0. Based on the collected historical data, these final values make sense as probabilities.

For example, the likelihood of a name causing an error is quite low, almost negligible. Since VM15 does not appear in the historical data of Table 2, the prior probability of 0.01 is used as the raw value.

On the other hand, when network2 is selected as the network, an error has resulted one-third of the time. Thus, the raw value of 0.33 is in agreement with the historical data.

Similarly, when network2 is selected as the network and subnet99 is selected as the subnet, an error has resulted one-third of the time. Thus, the raw value of 0.33 is also in agreement with the historical data.

In contrast, an error has resulted every time SG100 is selected as security group, network2 is selected as the network, and subnet99 is selected as the subnet. Thus the raw value of 1.00 is also in agreement with the historical data.

As a further illustration, if SG100 was replaced by SG99 in this example, then the raw value would be:

$$P ( error \vert SG 99 , subnet 99 , network 2 ) = \frac{P ( error , SG 99 , subnet 99 , network 2 )}{P ( SG 99 , subnet 99 , network 2 )} = 0.0$$

This indicates that SG99 is much less likely to result in an error when combined with subnet99 and network2.

When a request results in an error, the raw and/or normalized probabilities may be calculated and provided to the user in one way or another to indicate which of the input values may be the cause of the error. In some cases, the probabilities of all input values may be provided to the user. In other cases, only probabilities above a threshold value (e.g., 0.1, 0.15, 0.2, or 0.25) are provided. In yet other cases, only the top one, two, or three most likely inputs to have caused the error are flagged.

Further, in cases where enough data is available, one or more suggestions of alternative input values may be made. For instance, given the above estimations for the probabilities of SG100 and SG99 being the cause of an error in a request also involving network2 and subnet99, an input value for SG100 may be flagged as the likely cause of the error and SG99 may be suggested in its stead. In general, when multiple such calculations for different input values of an input are available, the input value with the lowest probability of an error (or the n input values with the n lowest probabilities of an error) may be suggested.

The embodiments herein generally presume that a request containing input values is submitted from a user interface of a client device to a server device (e.g., of a remote network management platform), an error is detected by the server device, and then the server device transmits an update to the user interface indicating the input value(s) most likely to have caused the error. This arrangement is advantageous because the server device will more easily have access to the historical data from which to calculate probabilities. Nonetheless, other arrangements are possible.

For example, using asynchronous web-based techniques and client-side scripting, input values can be provided to the server device as they are entered by the user. The server device might determine errors and calculate probabilities in real time and provide proactive feedback and/or suggestion by way of the user interface. For example, if the user enters network2 and subnet99 into user interface 800, then attempts to enter SG100, the user might be warned that adding SG100 to the combination of network2 and subnet99 has a high probability of causing an error.

In another possible arrangement, the server device may pre-calculate probabilities (e.g., the probabilities of Table 3 and any probabilities related to error likelihoods of other combinations of input values) and provide these probabilities as metadata to the client device. This metadata may be embedded in the markup language that defines the user interface, for example. The client device may then proactively generate a warning for display on the user interface when the user enters a combination of input values that is likely to cause an error, and before the user submits the request to the server device. Advantageously, this can be done without providing any input values or a request to the server device, resulting in faster responsiveness to the user and less load on the server device.

C. Determining Prior Probabilities

As noted above, when historical data is not available, prior probabilities may be used as seed values. This is illustrated above in the case of the input value of VM15 for the name input. Since this input value is not in the historical data for the name input, the pre-determined default value of 0.01 may be used.

In general, the prior probabilities may be obtained in a number of ways. For example, an expert in the system related to the inputs may determine, based on his or her personal experience and/or collected data, these probabilities. In some situations, prior probabilities can be based on telemetry data collected by way of IT service management procedures; that is, incident reports, problem reports, help requests, and so on submitted in relation to a user interface or the system to which it relates.

Notably, the prior probabilities can be effective even if they are just rough estimates or even if they are randomly chosen. This is because, as historical data arrives to the server device, this data can be used to “correct” the seed values. In some cases, the collected historical data, when available, is used to replace the prior probabilities. In other cases, the amount of collected historical data is used in a weighted average with the prior probabilities. For example, as the amount of collected historical data grows, less and less weight is given to the prior probabilities.

### VIII. Example Operations

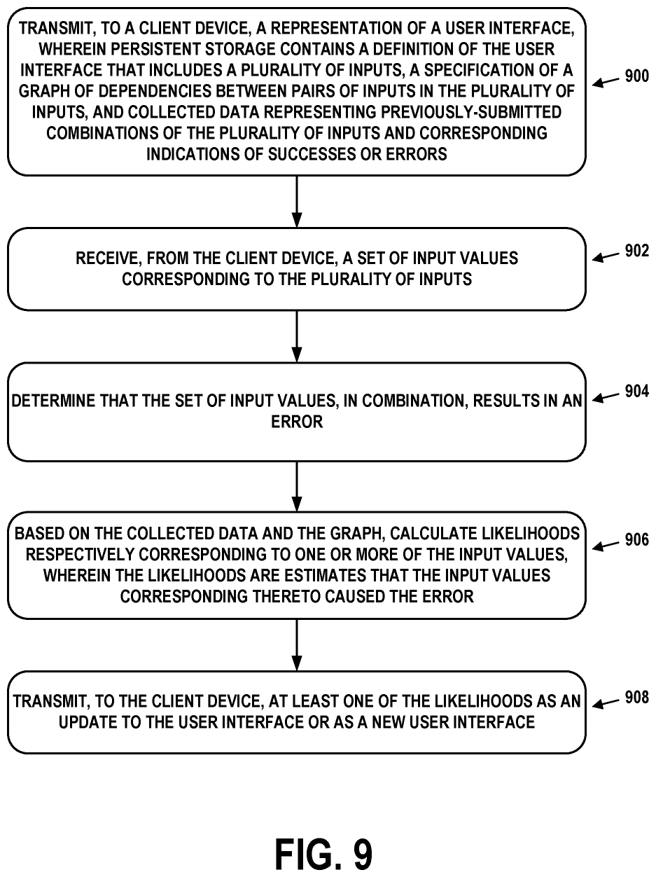

FIG. 9 is a flow chart illustrating an example embodiment. The process illustrated by FIG. 9 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 9 may be simplified by the removal of any one or more of the features shown therein. Further, these embodiments may be combined with features, aspects, and/or implementations of any of the previous figures or otherwise described herein.

Block 900 may involve transmitting, to a client device, a representation of a user interface, wherein persistent storage contains a definition of the user interface that includes a plurality of inputs, a specification of a graph of dependencies between pairs of inputs in the plurality of inputs, and collected data representing previously-submitted combinations of the plurality of inputs and corresponding indications of successes or errors.

Block 902 may involve receiving, from the client device, a set of input values corresponding to the plurality of inputs.

Block 904 may involve determining that the set of input values, in combination, results in an error.

Block 906 may involve, possibly based on the collected data and the graph, calculating likelihoods respectively corresponding to one or more of the input values, wherein the likelihoods are estimates that the input values corresponding thereto caused the error.

Block 908 may involve transmitting, to the client device, at least one of the likelihoods as an update to the user interface or as a new user interface.

In some embodiments, nodes in the graph respectively correspond to the plurality of inputs, wherein edges between pairs of the nodes respectively correspond to the dependencies between the pairs of inputs.

In some embodiments, calculating the likelihoods comprises: identifying a node in the graph for which one or more other nodes in the graph have dependencies; and calculating a likelihood that an input value corresponding to the node caused the error based on a conditional probability of the error occurring given probabilities of the input value corresponding to the node and one or more further input values corresponding to the one or more other nodes.

In some embodiments, the probabilities of the input value corresponding to the node and one or more further input values corresponding to the one or more other nodes are derived from the collected data.

In some embodiments, the persistent storage also contains prior probabilities respectively corresponding to the input values, and wherein at least one of the probabilities of the input value corresponding to the node and one or more further input values corresponding to the one or more other nodes is based on an associated prior probability.

In some embodiments, the likelihood is based on a normalization of the conditional probability.

In some embodiments, calculating the likelihood comprises: constructing a tree from the graph with the node as root and the one or more other nodes as direct or indirect children of the node; and determining the conditional probability based on the tree.

In some embodiments, calculating the likelihoods comprises: identifying a node in the graph for which no other node has a dependency; and calculating a likelihood that an input value corresponding to the node caused the error based on the collected data.

In some embodiments, the user interface is a web page. These embodiments may further include determining the graph based on onLoad and onChange rules associated with the plurality of inputs as defined in client-side scripts of the web page.

In some embodiments, the persistent storage also contains pluralities of configuration items and relationships therebetween. These embodiments may further include determining the graph based on the relationships that are between pairs of the configuration items associated with the pairs of inputs.

In some embodiments, the at least one of the likelihoods comprises at most n of the likelihoods that are highest, wherein n is inclusively between 1 and 5.

In some embodiments, the at least one of the likelihoods comprises one or more of the likelihoods that are above a pre-determined threshold value.

In some embodiments, determining that the set of input values, in combination, results in the error comprises: transmitting, to a remote system, at least some of the input values; and receiving, from the remote system, an indication of the error.

### IX. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid state drive, or another storage medium.

The computer readable medium can also include non-transitory computer readable media such as computer readable media that store data for short periods of time like register memory and processor cache. The computer readable media can further include non-transitory computer readable media that store program code and/or data for longer periods of time. Thus, the computer readable media may include secondary or persistent long term storage, like ROM, optical or magnetic disks, solid state drives, or compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A system comprising:
persistent storage containing a definition of a user interface that includes a plurality of inputs, a specification of a graph of dependencies between pairs of inputs in the plurality of inputs, and collected data representing previously-submitted combinations of the plurality of inputs and corresponding indications of successes or errors; and
one or more processors configured to:
transmit, to a client device, a representation of the user interface;
receive, from the client device, a set of input values corresponding to the plurality of inputs;
determine that the set of input values, in combination, results in an error;
based on the collected data and the graph, calculate likelihoods respectively corresponding to one or more of the input values, wherein the likelihoods are estimates that the input values corresponding thereto caused the error; and
transmit, to the client device, at least one of the likelihoods as an update to the user interface or as a new user interface.

2. The system of claim 1, wherein nodes in the graph respectively correspond to the plurality of inputs, and wherein edges between pairs of the nodes respectively correspond to the dependencies between the pairs of inputs.

3. The system of claim 2, wherein calculating the likelihoods comprises:
identifying a node in the graph for which one or more other nodes in the graph have dependencies; and
calculating a likelihood that an input value corresponding to the node caused the error based on a conditional probability of the error occurring given probabilities of the input value corresponding to the node and one or more further input values corresponding to the one or more other nodes.

4. The system of claim 3, wherein the probabilities of the input value corresponding to the node and one or more further input values corresponding to the one or more other nodes are derived from the collected data.

5. The system of claim 3, wherein the persistent storage also contains prior probabilities respectively corresponding to the input values, and wherein at least one of the probabilities of the input value corresponding to the node and one or more further input values corresponding to the one or more other nodes is based on an associated prior probability.

6. The system of claim 3, wherein the likelihood is based on a normalization of the conditional probability.

7. The system of claim 3, wherein calculating the likelihood comprises:
constructing a tree from the graph with the node as root and the one or more other nodes as direct or indirect children of the node; and
determining the conditional probability based on the tree.

8. The system of claim 2, wherein calculating the likelihoods comprises:
identifying a node in the graph for which no other node has a dependency; and
calculating a likelihood that an input value corresponding to the node caused the error based on the collected data.

9. The system of claim 1, wherein the user interface is a web page, and wherein the one or more processors are further configured to:
determine the graph based on onLoad and onChange rules associated with the plurality of inputs as defined in client-side scripts of the web page.

10. The system of claim 1, wherein the persistent storage also contains pluralities of configuration items and relationships therebetween, and wherein the one or more processors are further configured to:
determine the graph based on the relationships that are between pairs of the configuration items associated with the pairs of inputs.

11. The system of claim 1, wherein the at least one of the likelihoods comprises at most n of the likelihoods that are highest, wherein n is inclusively between 1 and 5.

12. The system of claim 1, wherein the at least one of the likelihoods comprises one or more of the likelihoods that are above a pre-determined threshold value.

13. The system of claim 1, wherein determining that the set of input values, in combination, results in the error comprises:
transmitting, to a remote system, at least some of the input values; and
receiving, from the remote system, an indication of the error.

14. A computer-implemented method comprising:
transmitting, to a client device, a representation of a user interface, wherein persistent storage contains a definition of the user interface that includes a plurality of inputs, a specification of a graph of dependencies between pairs of inputs in the plurality of inputs, and collected data representing previously-submitted combinations of the plurality of inputs and corresponding indications of successes or errors;
receiving, from the client device, a set of input values corresponding to the plurality of inputs;
determining that the set of input values, in combination, results in an error;
based on the collected data and the graph, calculating likelihoods respectively corresponding to one or more of the input values, wherein the likelihoods are estimates that the input values corresponding thereto caused the error; and
transmitting, to the client device, at least one of the likelihoods as an update to the user interface or as a new user interface.

15. The computer-implemented method of claim 14, wherein nodes in the graph respectively correspond to the plurality of inputs, and wherein edges between pairs of the nodes respectively correspond to the dependencies between the pairs of inputs.

16. The computer-implemented method of claim 15, wherein calculating the likelihoods comprises:
identifying a node in the graph for which one or more other nodes in the graph have dependencies; and
calculating a likelihood that an input value corresponding to the node caused the error based on a conditional probability of the error occurring given probabilities of the input value corresponding to the node and one or more further input values corresponding to the one or more other nodes.

17. The computer-implemented method of claim 16, wherein calculating the likelihood comprises:
constructing a tree from the graph with the node as root and the one or more other nodes as direct or indirect children of the node; and
determining the conditional probability based on the tree.

18. The computer-implemented method of claim 14, wherein the user interface is a web page, and wherein the computer-implemented method further comprises:
determine the graph based on onLoad and onChange rules associated with the plurality of inputs as defined in client-side scripts of the web page.

19. The computer-implemented method of claim 14, wherein the persistent storage also contains pluralities of configuration items and relationships therebetween, and wherein the computer-implemented method further comprises:
determine the graph based on the relationships that are between pairs of the configuration items associated with the pairs of inputs.

20. An article of manufacture including a non-transitory computer-readable medium, having stored thereon program instructions that, upon execution by a computing system, cause the computing system to perform operations comprising:
transmitting, to a client device, a representation of a user interface, wherein persistent storage contains a definition of the user interface that includes a plurality of inputs, a specification of a graph of dependencies between pairs of inputs in the plurality of inputs, and collected data representing previously-submitted combinations of the plurality of inputs and corresponding indications of successes or errors;
receiving, from the client device, a set of input values corresponding to the plurality of inputs;
determining that the set of input values, in combination, results in an error;
based on the collected data and the graph, calculating likelihoods respectively corresponding to one or more of the input values, wherein the likelihoods are estimates that the input values corresponding thereto caused the error; and
transmitting, to the client device, at least one of the likelihoods as an update to the user interface or as a new user interface.
